(19) United States
(12) Patent Application Publication
(10) Pub. No.: US 2013/0181870 A1
(43) Pub. Date: Jul. 18, 2013

(54) ANTENNA AND MOBILE TERMINAL INCLUDING THE ANTENNA

(71) Applicant: Masaki Suzuki, Shizuoka (JP)

(72) Inventor: Masaki Suzuki, Shizuoka (JP)

(73) Assignees: NEC CASIO MOBILE COMMUNICATIONS LTD., Kanagawa (JP); NEC ACCESS TECHNICA, LTD., Shizuoka (JP)

(21) Appl. No.: 13/824,083

(22) PCT Filed: Sep. 13, 2011
(86) PCT No.: PCT/JP2011/070845

§ 371 Date: Mar. 15, 2013

(30) Foreign Application Priority Data
Nov. 17, 2010 (JP) 2010-256375

(51) Int. Cl. H01Q 21/00

(52) U.S. Cl. CPC H01Q 21/00
USPC 343/700 MS

(57) ABSTRACT

Provided is an antenna capable of preventing deterioration of antenna radiation characteristics in any of the open state, the closed state, and the reverse state of a mobile terminal. The antenna includes: a pair of antenna elements 1 and 2 arranged to be parallel to each other and to face each other; connecting member 3 for connecting the pair of antenna elements 1 and 2 at the tips thereof to electrically short-circuit the same; and power supply members 4 and 5 capacitively coupled to the feeding points of the pair of antenna elements 1 and 2 to supply power.

### TECHNICAL FIELD

The present invention relates to an antenna for receiving GPS radio waves, and a mobile terminal including the antenna.

### BACKGROUND ART

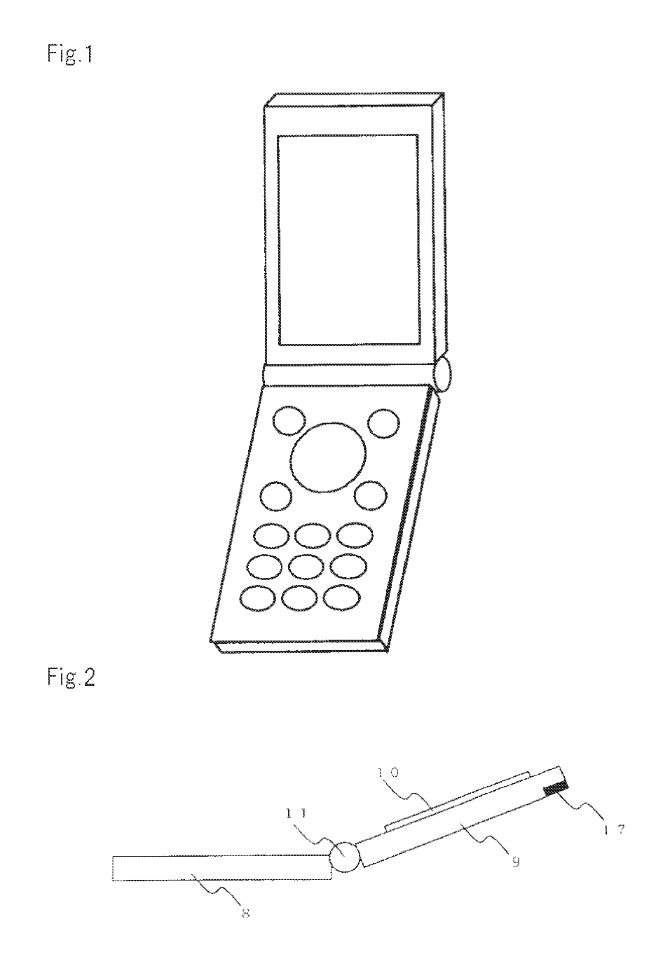

In a foldable mobile terminal shown in FIG. 1, and FIG. 2, display side case 9 having display unit 10 can be opened (open state) by hinge 11 with respect to operation side case 8 having an operation unit. In this case, antenna 17 that receives GPS radio waves is often disposed at the tip of display side case 9. This is for the purpose of facilitating reception of radio waves from a sky GPS satellite when the navigation function or the like is used with the foldable mobile terminal set in the open state.

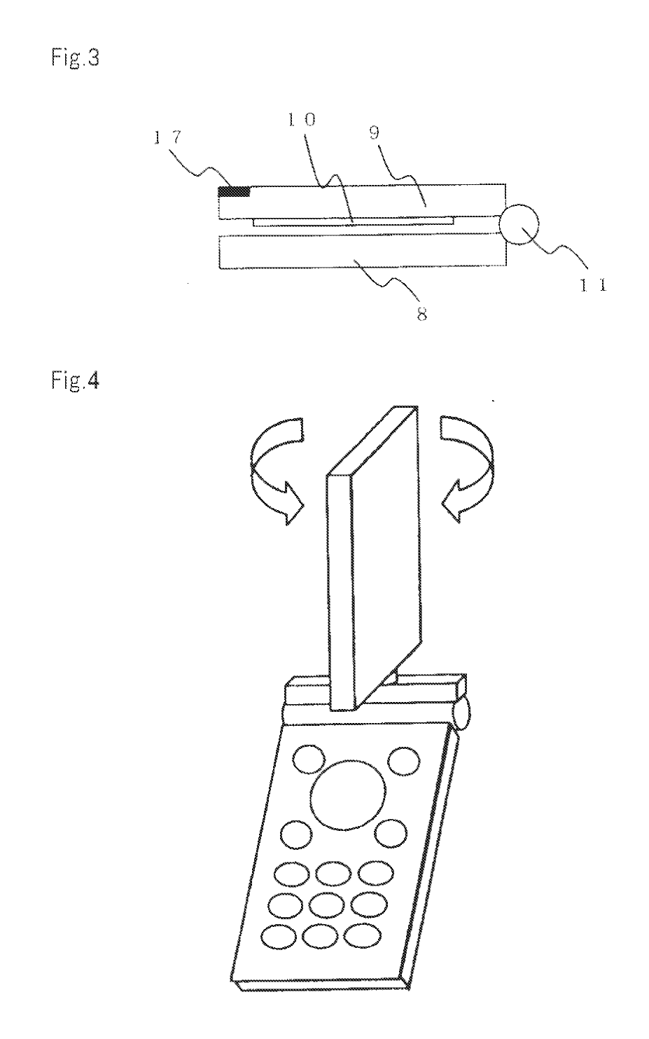

As shown in FIG. 3, a situation where positional information is acquired while both cases 8 and 9 of the mobile terminal are closed (closed state) has gained in popularity. Accordingly, to maintain a good reception state even in the closed state, GPS antenna 17 is located as far as possible from operation side case 8. The reason for locating GPS antenna 17 as far as possible from operation side case 8 is because operation side case 8 includes many metals such as batteries or substrates and this may cause radiation characteristics to deteriorate if the case 8 is in close proximity to antenna 17.

With the popularization of a touch panel, as shown in FIG. 4, a mobile terminal foldable (reverse state) with display unit 10 set so that it can be seen by the user by rotating display side case 9 has come into wide use.

The recent popularization of the touch panel has been accompanied by the increase of situations where the mobile terminal is used in a folded state so that the display unit is visible and, as shown in FIG. 4, the mobile terminals that have a mechanism of rotating the case of a liquid crystal side has come into wide use. In such a reverse state, the antenna comes into close proximity to the operation side case, and this may cause a major deterioration in radiation characteristics.

Thus, whether the mobile terminal is in the closed state or the reverse state, the antenna is positioned such that a uniform distance is maintained from the operation side case, thereby preventing deterioration in characteristics.

However, this antenna arrangement has a problem in which the radiation characteristics deteriorate to a greater degree than in an ordinary foldable mobile terminal (mobile terminal that cannot be set in a reverse state).

The examples of the antenna used for the mobile terminal are disclosed in Patent Literature 1 (JP2003-209482A) and Patent Literature 2 (JP2009-100362A).

### Citation List

Patent Literature 1: JP2003-209482A

Patent Literature 2: JP2009-100362A

### SUMMARY OF INVENTION

### Problems to be Solved by Invention

As described above, in the mobile terminal that can be set in the closed state (also in the reverse state) with the display unit set visible, there is a problem of deterioration of the radiation characteristics of the antenna in the reverse state.

It is therefore an object of the present invention to provide an antenna in which deterioration of the radiation characteristics of an antenna can be prevented in the opened state, the closed state, and the reverse state of a mobile terminal, and a mobile terminal including the antenna.

### Solution to Problem

To achieve the object, according to the present invention, an antenna includes: a pair of antenna elements arranged to be parallel to each other and to face each other; a connecting member for connecting the pair of antenna elements at the tips thereof to electrically short-circuit the same; and power supply members capacitively coupled to the feeding points of the pair of antenna elements to supply power.

To achieve the object, according to the present invention, a mobile terminal includes the aforementioned antenna.

### Effects of Invention

The present invention employs a structure where the two antenna elements are symmetrically arranged, and good radiation characteristics can be maintained even if one of the antenna elements comes into close proximity to the metal. Since the antenna elements are symmetrical, even if both antenna elements come into close proximity to the metal, good radiation characteristics can be maintained. When used in the mobile terminal, irrespective of the state of the mobile terminal, i.e., the open state, the closed state, or the reverse state, good radiation characteristics can be acquired.

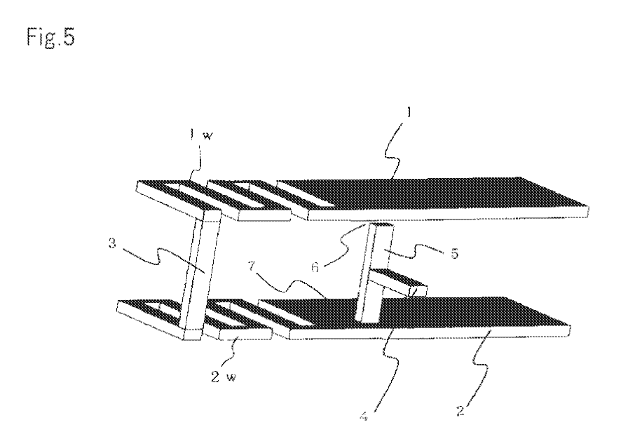

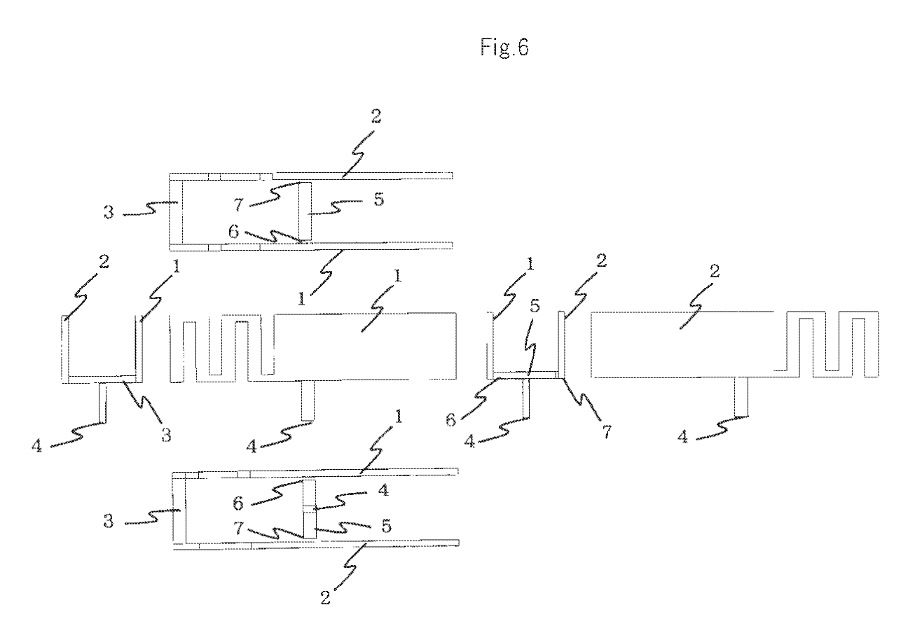

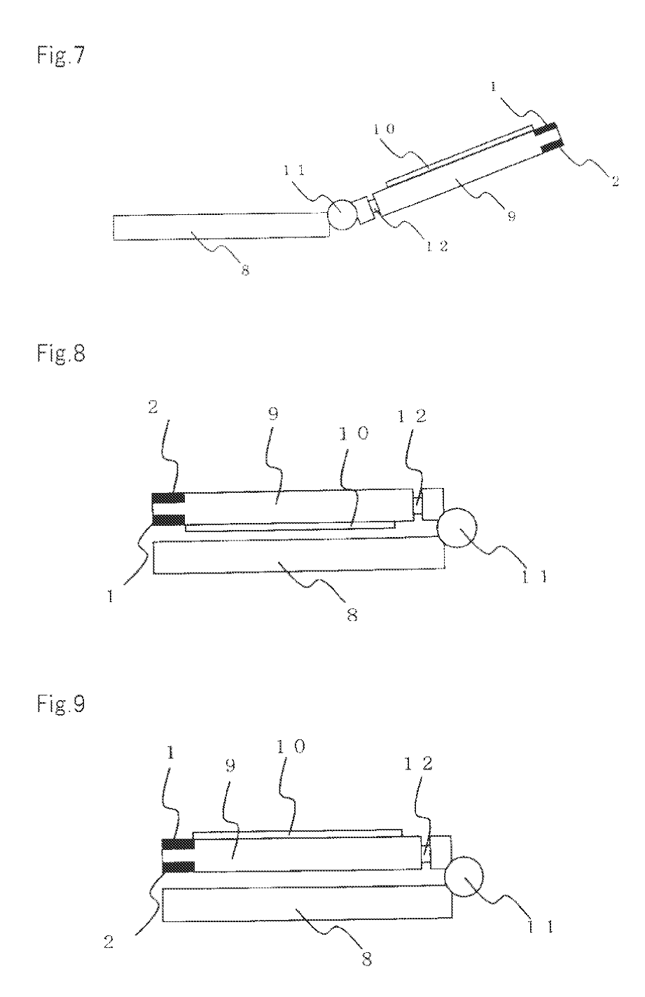

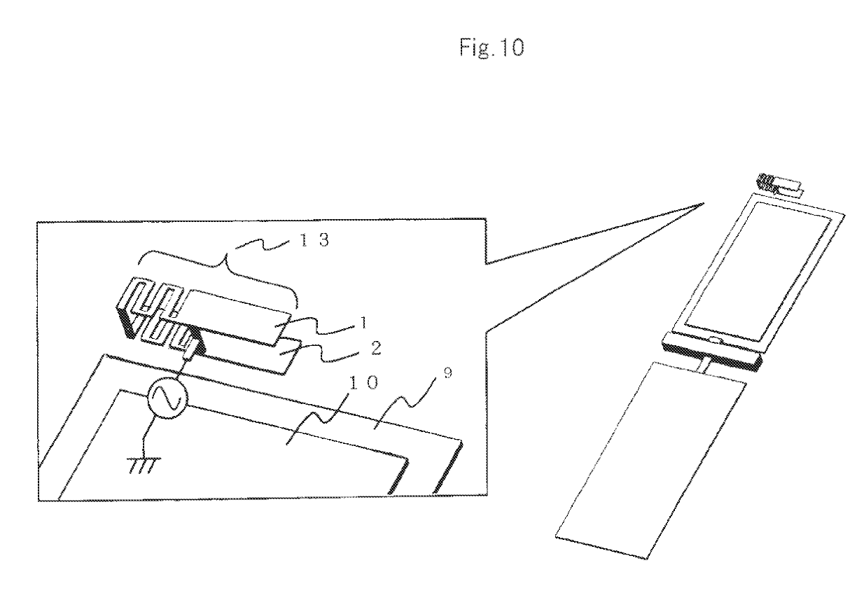

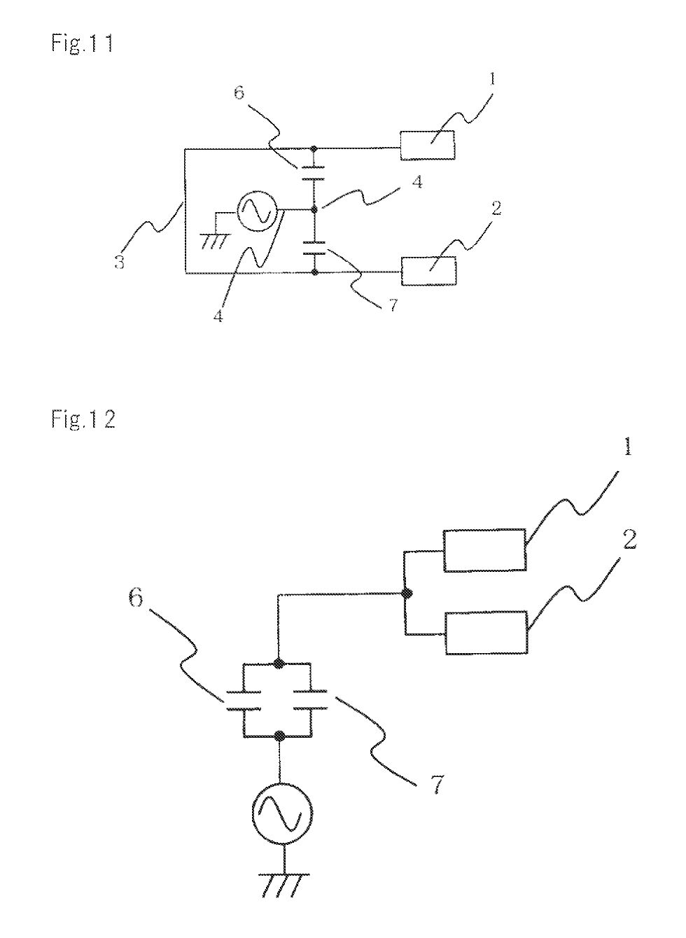

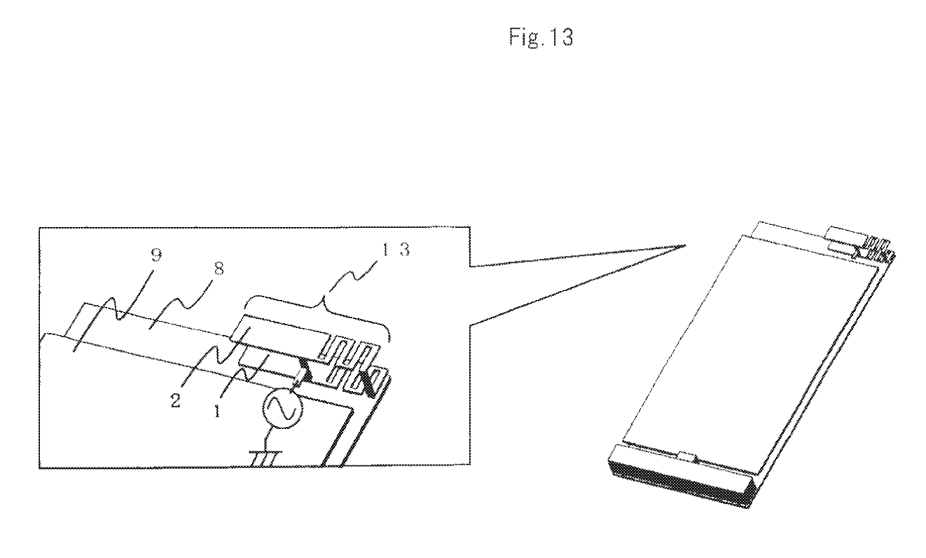

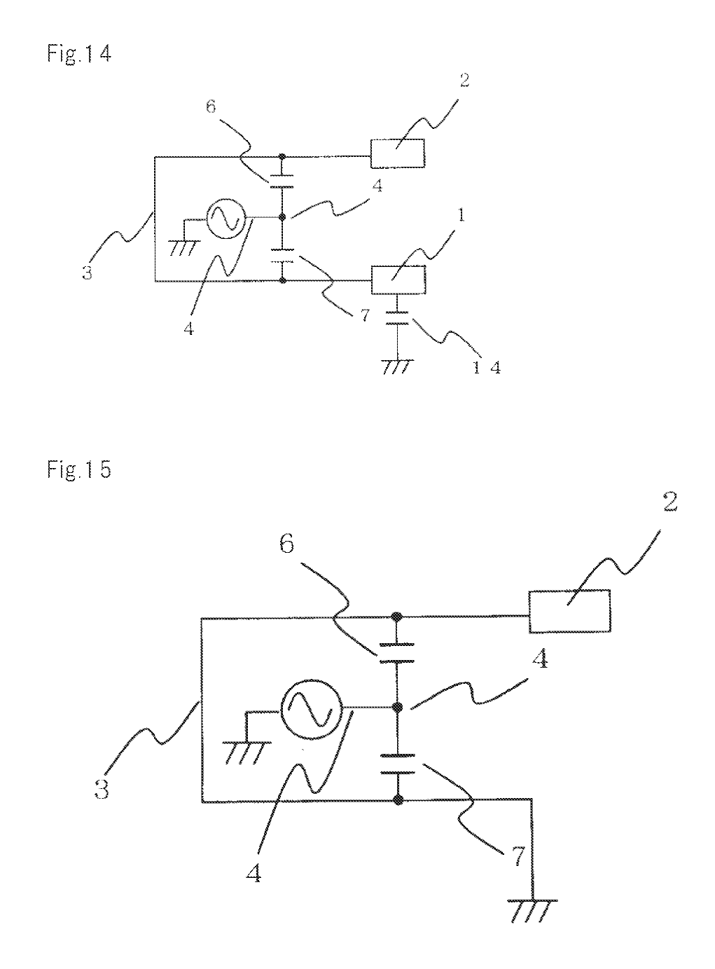

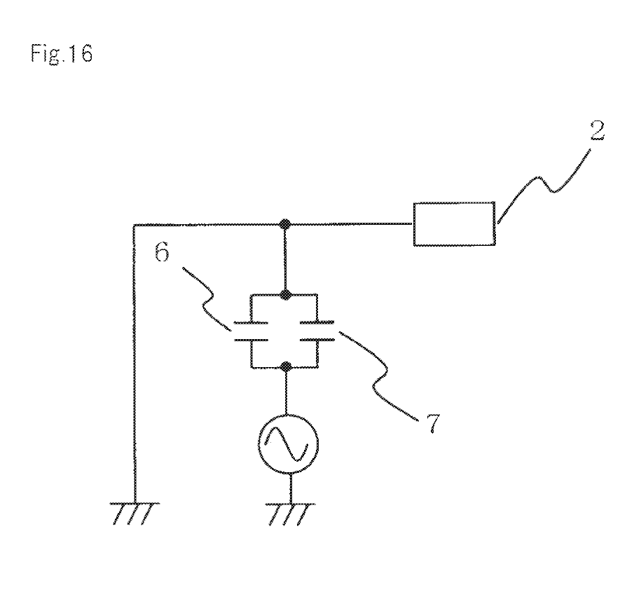

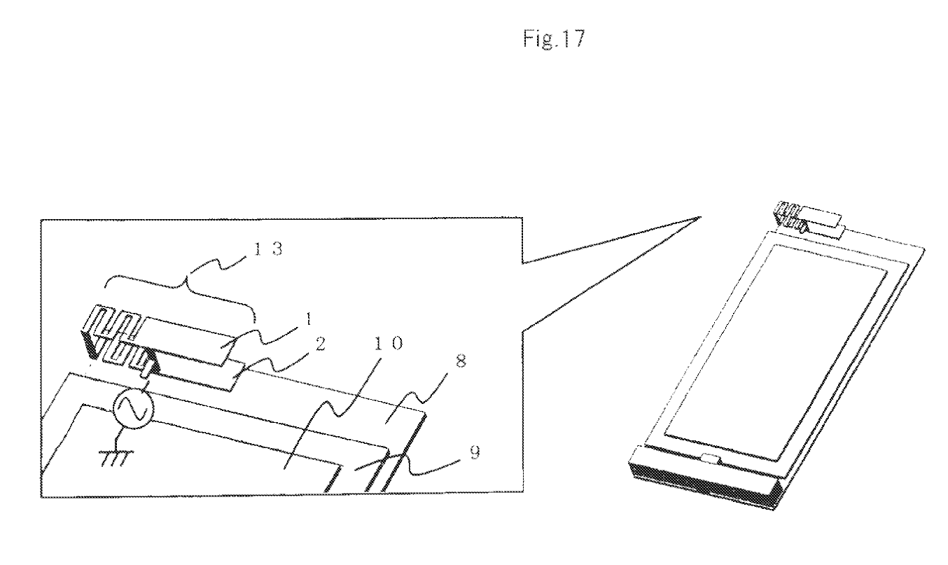

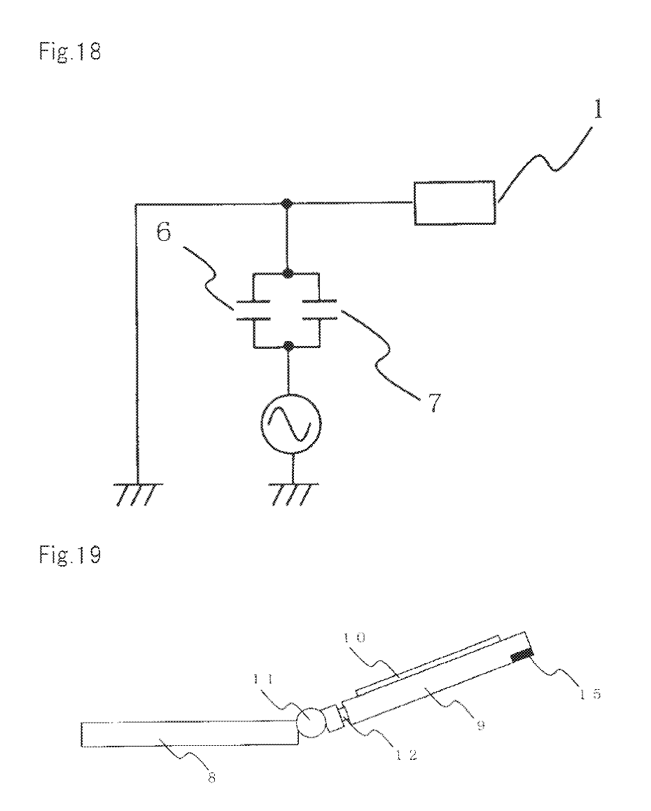

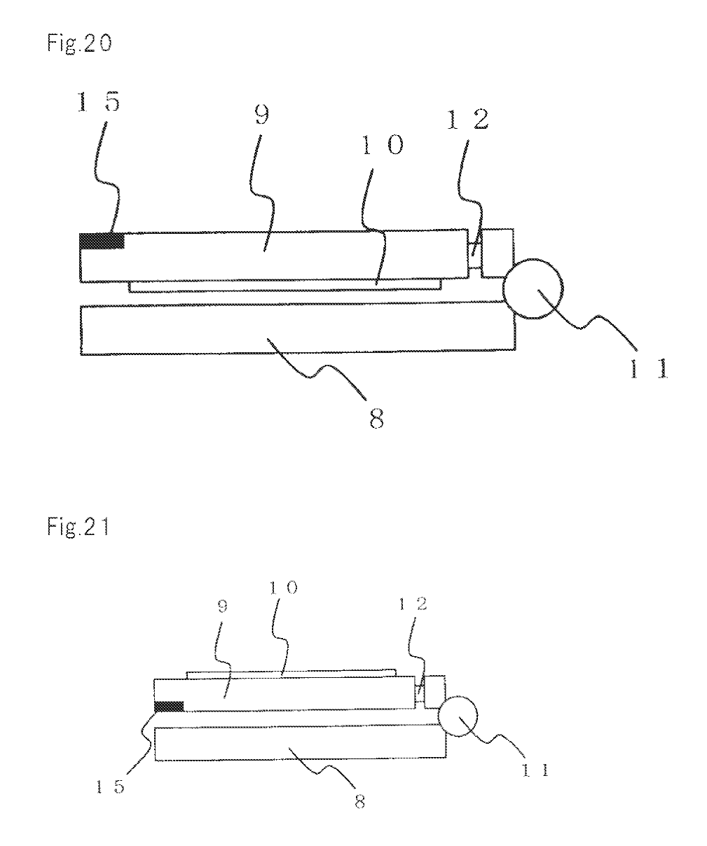

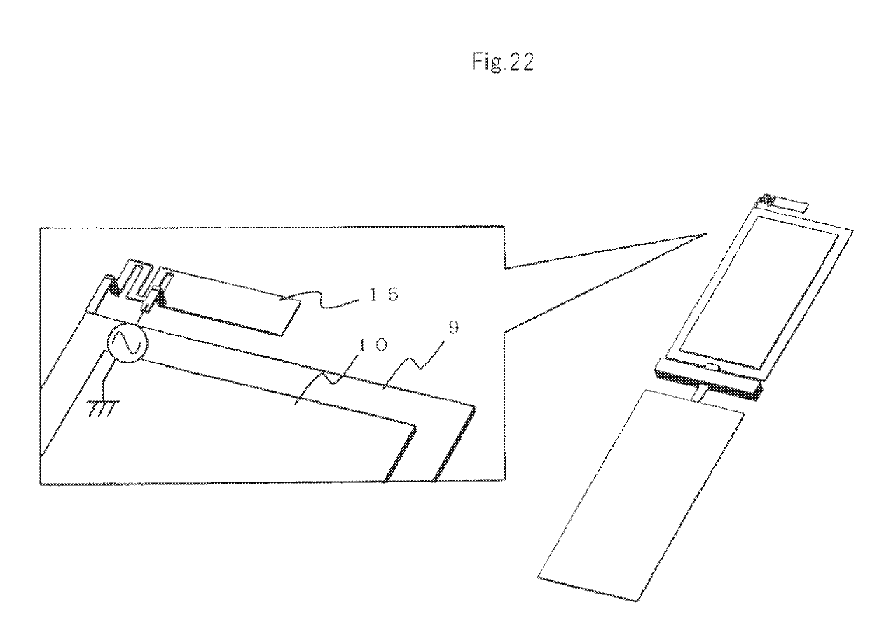

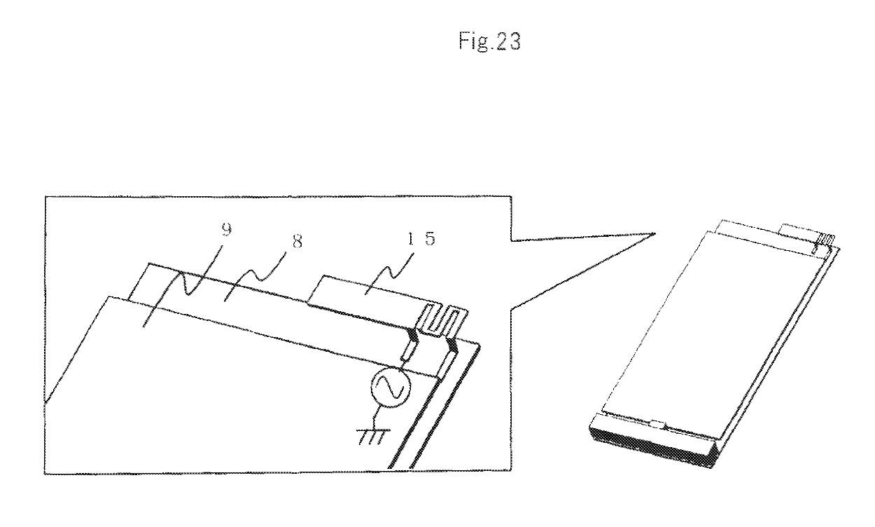

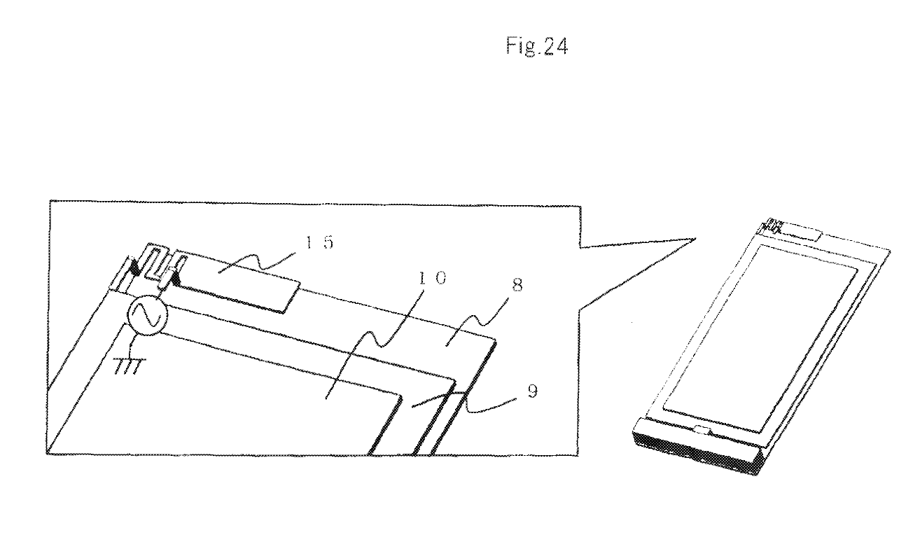

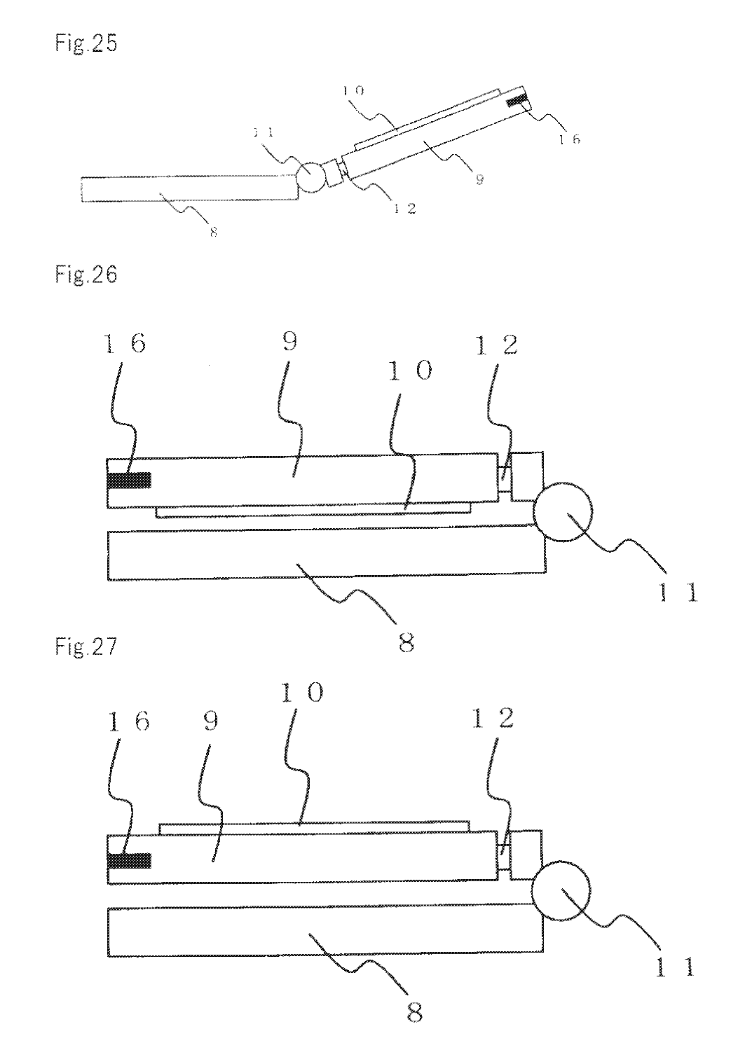

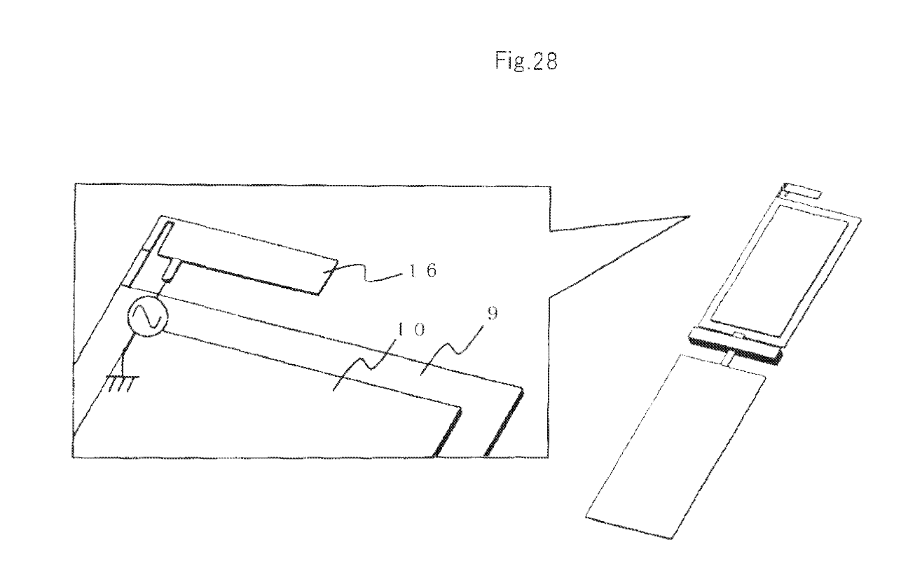

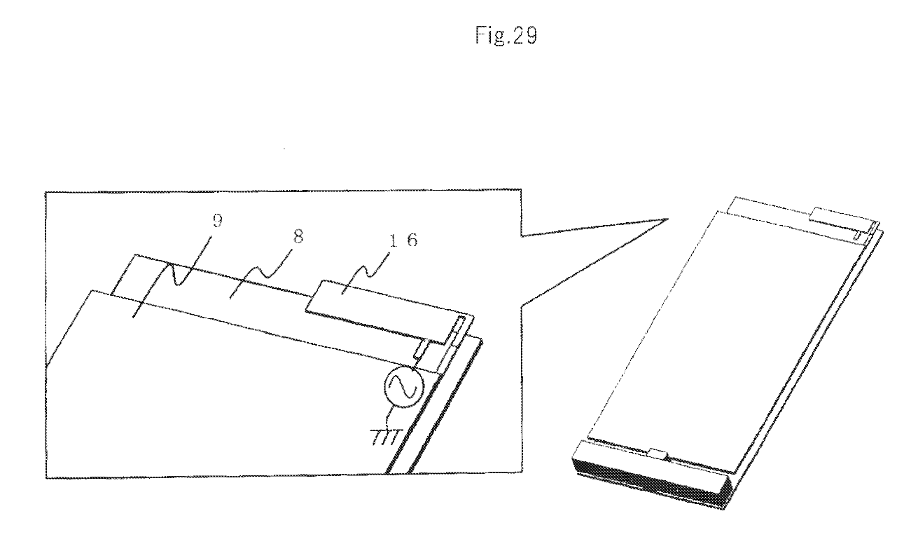

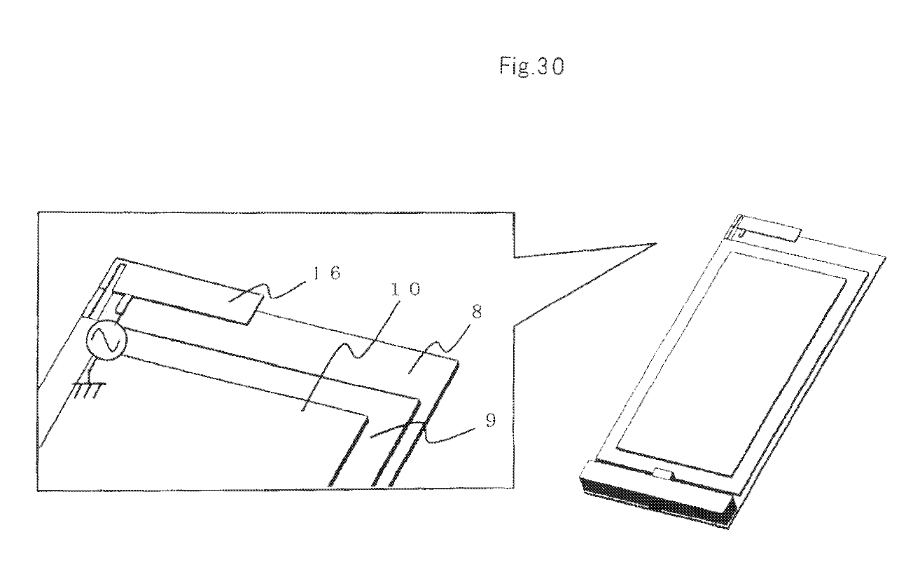

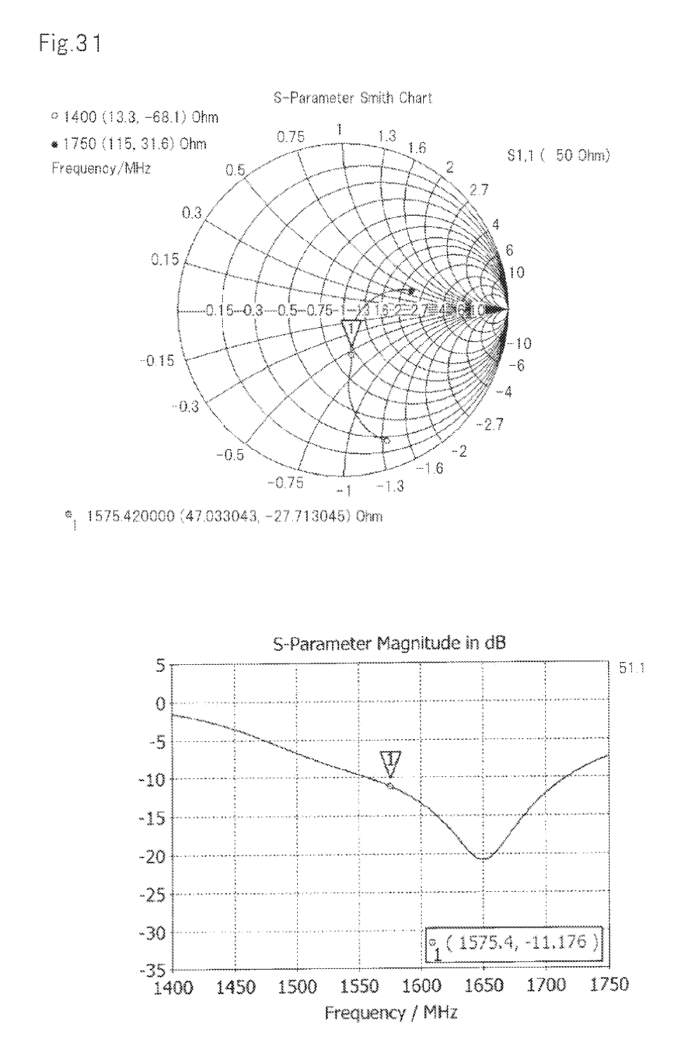

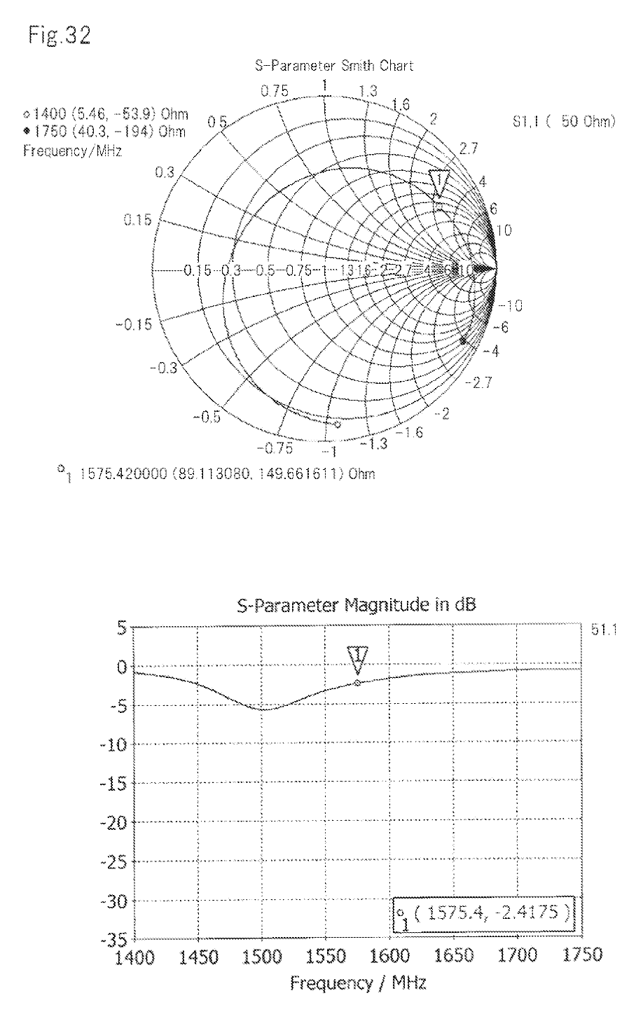

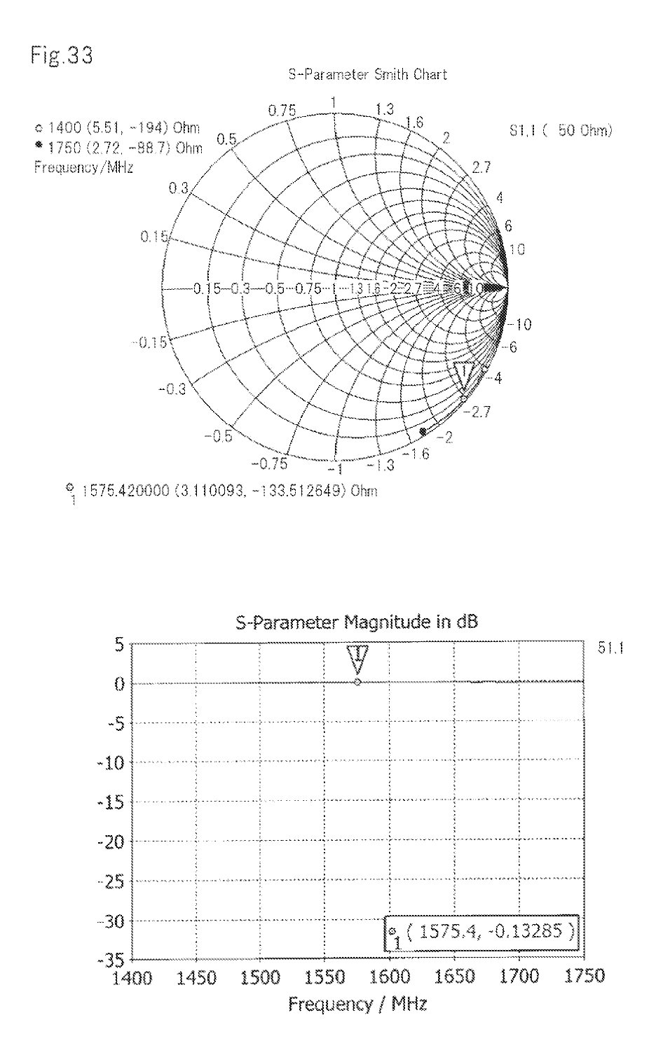

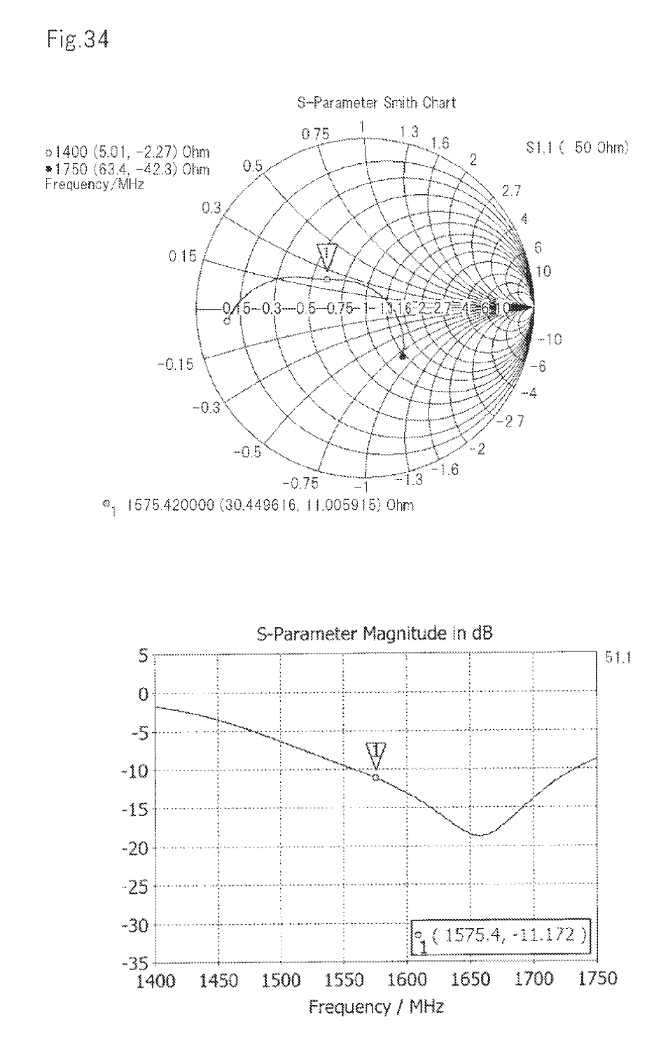

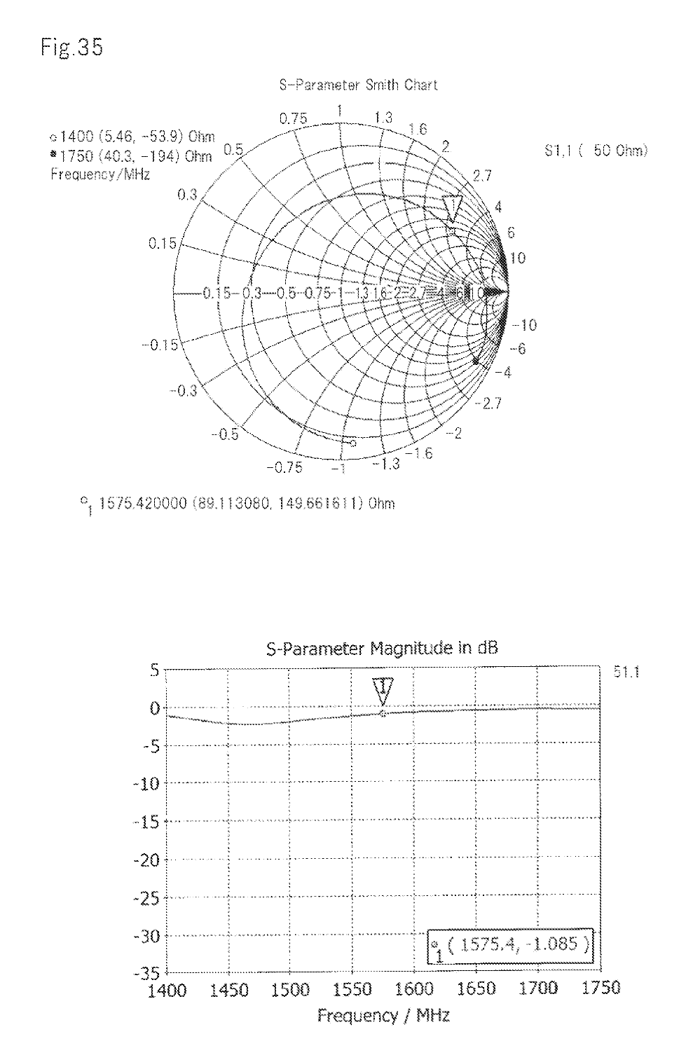

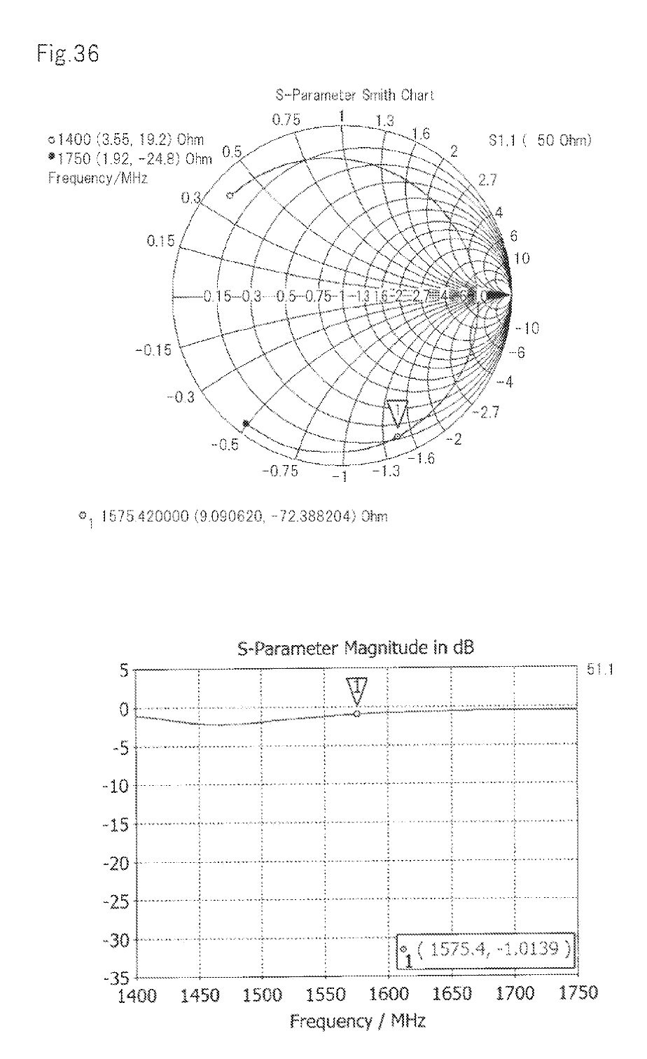

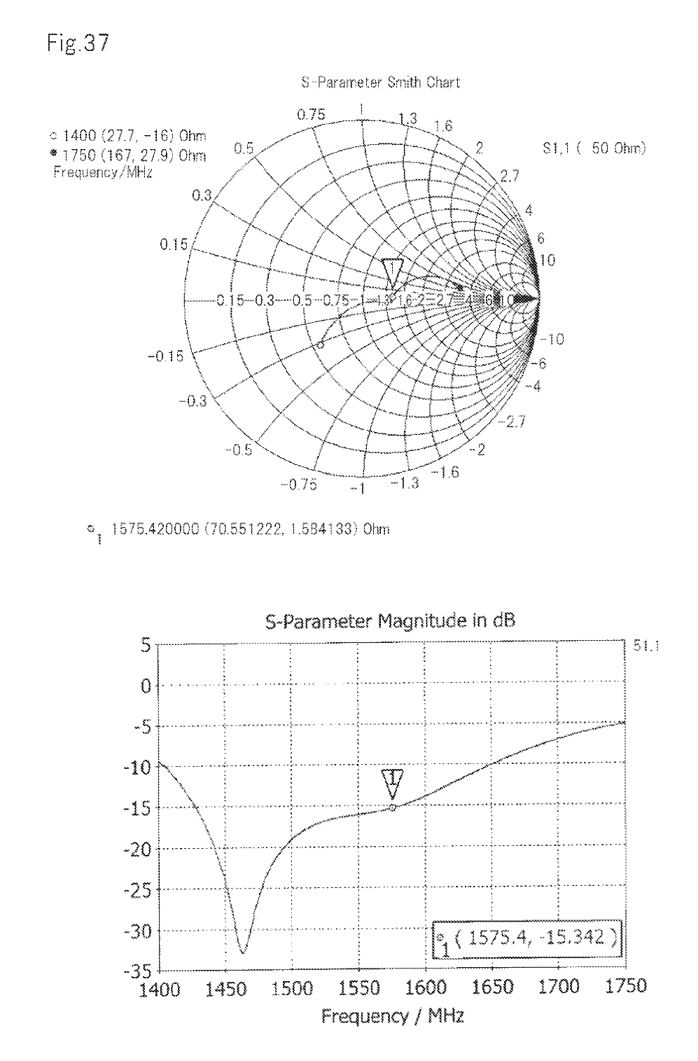

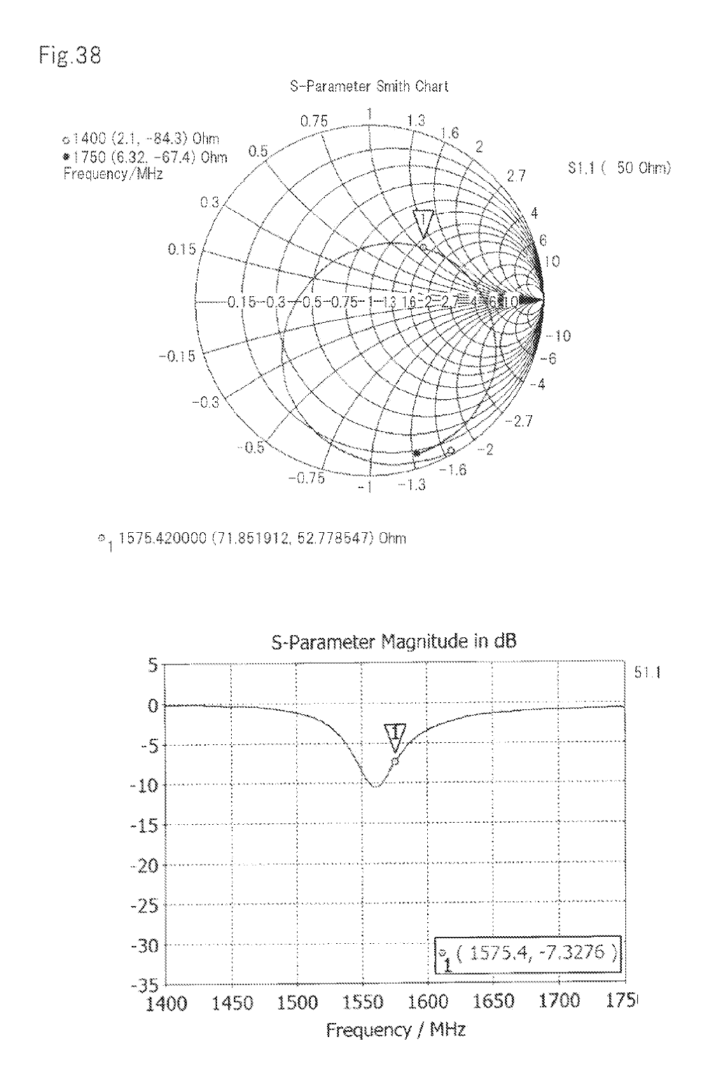

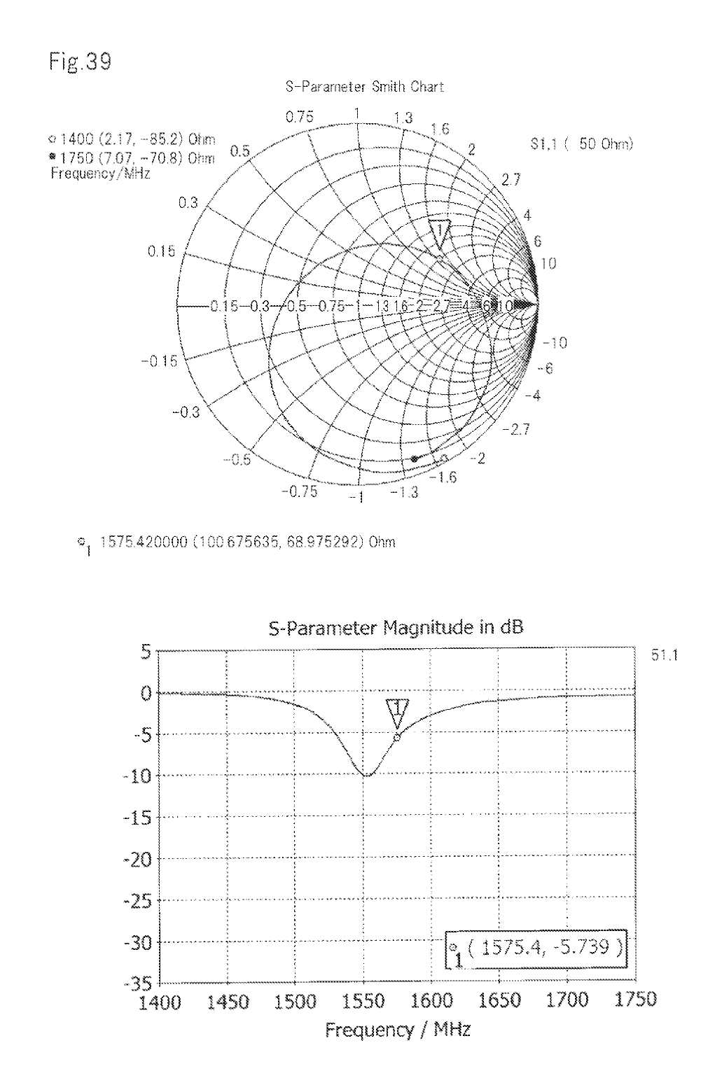

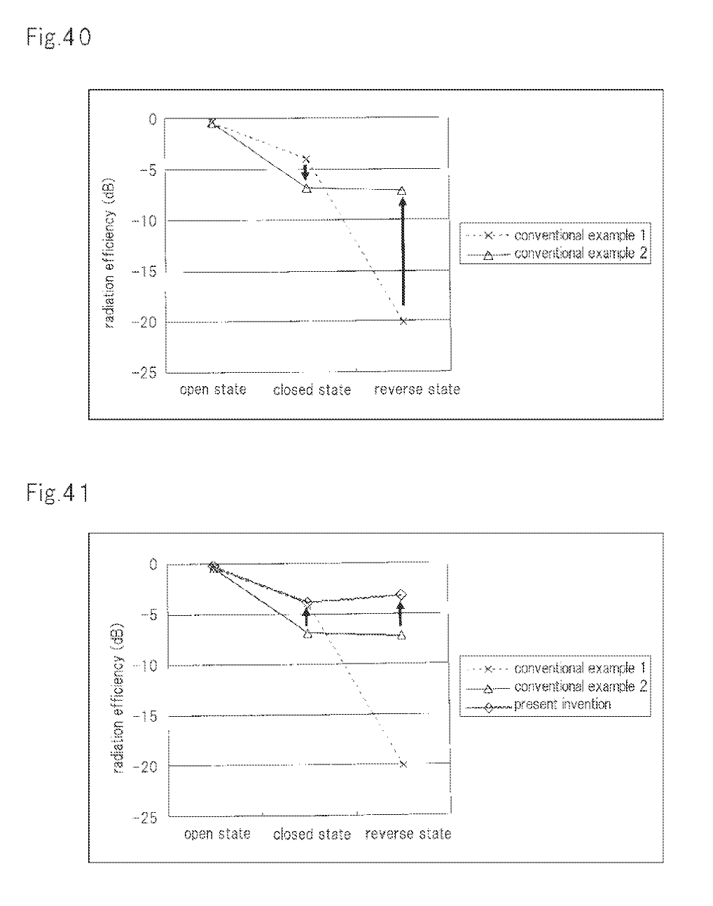

### BRIEF DESCRIPTION OF DRAWINGS

[FIG. 1] An explanatory view showing an example of a foldable mobile terminal according to the present invention.

[FIG. 2] A view showing the open state of the mobile terminal shown in FIG. 1.

[FIG. 3] A view showing a closed state where the mobile terminal shown in FIG. 1 is folded.

[FIG. 4] A view showing a state where the display unit of the mobile terminal shown in FIG. 1 rotates.

[FIG. 5] A perspective view showing an antenna according to the embodiment of the present invention.

[FIG. 6] A hexagonal view showing the antenna shown in FIG. 5.

[FIG. 7] A view showing the open state of the mobile terminal including the antenna shown in FIG. 5.

[FIG. 8] A view showing the closed state of the mobile terminal shown in FIG. 5.

[FIG. 9] A view showing the reverse state of the mobile terminal shown in FIG. 5.

[FIG. 10] An enlarged view showing an antenna portion in the open state shown in FIG. 7.

[FIG. 11] A view showing the equivalent circuit of the antenna in the open state shown in FIG. 7.

[FIG. 12] A simplified view showing the equivalent circuit shown in FIG. 11.

[FIG. 13] An enlarged view showing the antenna portion in the closed state of the mobile terminal including the antenna of the embodiment. shown in FIG. 7.

[FIG. 14] A view showing the equivalent circuit of the antenna in the closed state shown in FIG. 13.

[FIG. 15] A further view showing the equivalent circuit shown in FIG. 14.

[FIG. 16] A simplified view showing the equivalent circuit shown in FIG. 15.

[FIG. 17] An enlarged view showing the antenna portion in the reverse state of the mobile terminal including the antenna of the embodiment.

[FIG. 18] A view showing the equivalent circuit of the antenna in the reverse state shown in FIG. 17.

[FIG. 19] A view showing an antenna arrangement in the open state of a mobile terminal according to “Conventional Example 1” that is one of mobile terminals related to the present invention.

[FIG. 20] A view showing the antenna arrangement in the closed state of the mobile terminal shown in FIG. 19.

[FIG. 21] A view showing the antenna arrangement in the reverse state of the mobile terminal shown in FIG. 19.

[FIG. 22] A view showing the simulation model of the antenna arrangement in the open state shown in FIG. 19.

[FIG. 23] A view showing the simulation model of the antenna arrangement in the closed state shown in FIG. 20.

[FIG. 24] A view showing the simulation model of the antenna arrangement in the reverse state shown in FIG. 21.

[FIG. 25] A view showing an antenna arrangement in the open state of a mobile terminal according to “Conventional Example 2” that is the other of the mobile terminals related to the present invention.

[FIG. 26] A view showing the antenna arrangement in the closed state of the mobile terminal shown in FIG. 25.

[FIG. 27] A view showing the antenna arrangement in the reverse state of the mobile terminal shown in FIG. 25.

[FIG. 28] A view showing the simulation model of the antenna arrangement in the open state shown in FIG. 25.

[FIG. 29] A view showing the simulation model of the antenna arrangement in the closed state shown in FIG. 26.

[FIG. 30] A view showing the simulation model of the antenna arrangement in the reverse state shown in FIG. 27.

[FIG. 31] A view showing impedance and a return loss that are simulation results in the open state of the mobile terminal according to “Conventional Example 1”.

[FIG. 32] A view showing impedance and a return loss that are simulation results in the closed state of the mobile terminal according to “Conventional Example 1”.

[FIG. 33] A view showing impedance and a return loss that are simulation results in the reverse state of the mobile terminal according to “Conventional Example 1”.

[FIG. 34] A view showing impedance and a return loss that are simulation results in the open state of the mobile terminal according to “Conventional Example 2”.

[FIG. 35] A view showing impedance and a return loss that are simulation results in the closed state of the mobile terminal according to “Conventional Example 2”.

[FIG. 36] A view showing impedance and a return loss that are simulation results in the reverse state of the mobile terminal according to “Conventional Example 2”.

[FIG. 37] A view showing impedance and a return loss that are simulation results in the open state of the mobile terminal according to the embodiment.

[FIG. 38] A view showing impedance and a return loss that are simulation results in the closed state of the mobile terminal according to the embodiment.

[FIG. 39] A view showing impedance and a return loss that are simulation results in the reverse state of the mobile terminal according to the embodiment.

[FIG. 40] A view showing the comparison of characteristics between the mobile terminal according to “Conventional Example 1” and the mobile terminal according to “Conventional Example 2”.

[FIG. 41] A view showing the effects of the mobile terminal of the present invention in the comparison between the mobile terminal according to “Conventional Example 1” and the mobile terminal according to “Conventional Example 2”.

### DESCRIPTION OF EMBODIMENTS

Hereinafter, the embodiments of the present invention will be described with reference to the drawings. FIG. 5 is a perspective view showing an antenna according to the embodiment of the present invention. FIG. 6 is a hexagonal view showing the antenna shown in FIG. 5.

Referring to FIGS. 5 and 6, the antenna according to the present invention basically includes two elements, i.e., antenna element 1 and antenna element 2. The pair of antenna elements 1 and 2 are connected at the tips thereof by connecting member 3 to be electrically short-circuited.

A T-shaped power supply unit including members 4 and 5 is disposed roughly at the center (feeding point) of antenna elements 1 and 2. Member 5 is a power supply member, and member 4 is a connection member connected to a not-shown wireless unit.

Gaps 6 and 7 are created between antenna elements 1 and 2 and power supply member 5.

Antenna elements 1 and 2 and power supply member 5 are capacitively coupled to each other via gaps 6 and 7 to supply power.

The pair of antenna elements 1 and 2 includes rectangular flat-plate portions and bent portions (1w, 2w) at the tips of the flat-pate portions. The flat-plate portions are connected with a certain interval by connecting member 3 to be parallel to each other and to face each other. Accordingly, antenna elements 1 and 2 are linearly symmetrical to each other. Connecting member 3 connects antenna elements 1 and 2 at the tips of bent portions 1w and 2w located at the tips of antenna elements 1 and 2.

Antenna elements 1 and 2 have flat-plate shapes. However, antenna elements 1 and 2 are not limited to these shapes. For example, rod shapes or U shapes can be employed. Bent portions 1w and 2w define effective lengths of the antenna elements. The effective lengths of the antenna elements are proportionately longer in relation to the larger number of bent portions, and the corresponding frequency is lower. Conversely, the effective lengths of the antenna elements are proportionately shorter in relation to the smaller the number of bent portions, and the corresponding frequency is higher. Thus, if a reception frequency can be supported only by the flat-plate portions, bent portions 1w and 2w are unnecessary.

In the embodiment, the bent portions are formed to receive GPS radio waves, thereby responding to a GPS frequency.

Not limited to the shown example (roughly at the center of the antenna elements), the position of the power supply unit including members 4 and 5 can be set closer to connecting element 3. However, this case is undesirable because antenna radiation characteristics deteriorate.

In the antenna thus configured according to the embodiment, when one of the antenna elements comes into close proximity to a metal, this antenna element and the metal are capacitively coupled to each other to reduce a potential difference therebetween. When the metal is at a GND (ground) potential, the antenna element that comes into close proximity to the metal is also set equal to the GND potential. Accordingly, the antenna element operates as a reverse F-type antenna GND-grounded by connecting element 3.

Because of the presence of gaps 6 and 7 between power supply member 5 and antenna elements 1 and 2, power supply member 5 and antenna elements 1 and 2 are short-circuited, thereby preventing changes in antenna element length and supplying power to the feeding points of antenna elements 1 and 2.

Thus, even if one of the antenna elements comes into close proximity to the metal, good radiation characteristics can be maintained. Since the antenna elements are symmetrical, even if both antenna elements come into close proximity to the metal, similar radiation characteristics can be maintained.

In the antenna shown in FIGS. 5 and 6, metal conductors constituting antenna elements 1 and 2 are three-dimensionally arranged, and accuracy is required for the clearance between components. As an antenna manufacturing method, a manufacturing method that integrally forms a metal plate from resin or a manufacturing method that prints a metal film on a dielectric body represented by a chip antenna can be suitably used.

FIG. 7 schematically shows an example where the antenna according to the embodiment shown in FIGS. 5 and 6 is used for a mobile terminal. In FIG. 7, portions similar to those shown in FIGS. 5, 6, and 2 are denoted by similar reference numerals.

Operation side case 8 and display side case 9 having liquid crystal display unit 10 are connected by hinge 11. As shown in FIG. 8, display side case 9 is structured to be rotatable by rotary unit 12. This is one of the general configurations of the mobile terminal.

When the antenna according to the embodiment is located at the tip of display side case 9 of such a mobile terminal, antenna elements 1 and 2 are set in a shown positional relationship. Specifically, the antenna is housed in the case so that at the tip of display side case 9, the longitudinal direction of antenna elements 1 and 2 that are parallel to each other can be parallel to a direction orthogonal to the longitudinal direction of case 9.

FIG. 8 shows the folded state (closed state) of the mobile terminal shown in FIG. 7. Antenna element 1 is set at a position closest to operation side case 8 including many metals such as batteries or substrates, i.e., the position of large capacitive coupling. At this time, antenna element 2 is set at a position farthest from operation side case 8, i.e., the position having best radiation characteristics.

FIG. 9 shows a reverse state where the mobile terminal shown in FIG. 7 is folded so that liquid crystal display unit 10 is visible to the user. In this state, antenna element 2 is set at a position closest to operation side case 8, i.e., the position having large capacitive coupling. On the other hand, antenna element 1 is set at a position farthest from operation side case 8, i.e., the position having best radiation characteristics.

Next, the operation of the mobile terminal according to the embodiment, when it is used as shown in FIGS. 7 to 9, will be described. FIG. 10 shows the portion of antenna 3 enlarged by extracting a main metal portion in the open state of mobile terminal. Metals around antenna 13 are substrate 9 and display unit 10 of the display side case. These do not greatly affect the antenna characteristics.

FIG. 11 shows the equivalent circuit of the antenna in the open state. The configuration of the antenna is similar to that shown in FIG. 5, antenna elements 1 and 2 are connected by connecting member 3, and power is supplied by power supply unit 4 that is a connection member. Gaps between power supply unit 4 and antenna elements 1 and 2 are equivalently represented by capacitors 6 and 7 because of capacitive coupling. The equivalent circuit shown in FIG. 11 can be simplified to a circuit shown in FIG. 12. This is a reverse L-type antenna (or T-shaped) circuit. Accordingly, the operation of the antenna is similar to that of the reverse L-type antenna.

FIG. 13 shows the main metal portion in the closed state of the case. In the enlarged view of the antenna, metals around antenna 13 according to the present invention are substrate 9 of the display side case, substrate 8 of the operation side case, and display unit 10. Display unit 10 is located between substrate 9 of the display side case and substrate 8 of the operation side case in the closed state. In the closed state, antenna element 2 and substrate 8 of the operation side case are very close to each other, accordingly they are capacitively coupled.

FIG. 14 shows an equivalent circuit. In FIG. 14, capacitor 14 represents the capacity between antenna element 2 and substrate 8 of the operation side case. Since antenna element 2 and substrate 8 of the operation side case are very close to each other, the capacity value of capacitor 14 is very large, and can be approximated to 0 Ω. Accordingly, the equivalent circuit can be as shown in FIG. 15.

The equivalent circuit shown in FIG. 15 can be simplified to a circuit shown in FIG. 16. This is a reverse F-type antenna circuit. Accordingly, the antenna according to the present invention operates as a reverse F-type antenna in the closed state of the case.

FIG. 17 shows the main metal portion in the reverse state of the case. It is antenna element 1 that approaches substrate 8 of the operation side case. Other than this, the arrangement is similar to that in the case of the closed state, and thus description will be omitted. Thus, since an equivalent circuit is as shown in FIG. 18, as in the case of the closed state, the antenna also operates as the reverse F-type antenna in the reverse state of the case.

Antenna 1 according to the present invention employs the structure where the two antenna elements are arranged, and good radiation characteristics can be maintained even when one of the antenna elements comes into close proximity the metal. Since the antenna elements face each other in parallel and are symmetrical, both of the antenna element comes into close proximity to the metal, good radiation characteristics can be maintained. When used in the mobile terminal, irrespective of the state of the mobile terminal, i.e., the open state, the closed state, or the reverse state, good radiation characteristics can be acquired.

The effects of the present invention will be described by referring to the simulation results of an electromagnetic simulator. In this case, FIGS. 10, 13, and 17 show the simulation models of the open state, the closed state, and the reverse state of the antenna according to the present invention used for simulation.

Simulation models assuming conventional terminals for comparison are two types, i.e., “Conventional Example 1” and “Conventional Example 2”. “Conventional Example 1” pertains to an antenna arrangement similar to that of a normal foldable mobile terminal (type where display side case does not rotate). “Conventional Example 2” pertains to the antenna arrangement of the current model that is an improvement of “Conventional Example 1” in deterioration.

FIGS. 19 to 21 show the antenna arrangement in the open state, the closed state, and the reverse state of according to “Conventional Example 1”, and FIGS. 22 to 24 show simulation models thereof.

FIGS. 25 to 27 show the antenna arrangement of the open state, the closed state, and the reverse state of the antenna according to “Conventional Example 2”, and FIGS. 28 to 30 show simulation models thereof.

The antennas according to “Conventional Example 1” and “Conventional Example 2” are similar in configuration to that shown in FIGS. 7 to 10, 13, and 17 except for the antenna elements, and thus description will be omitted. Antenna element 15 according to “Conventional Example 1” and antenna element 16 according to “Conventional Example 2” are slightly different in shape from each other, which is a result of adjustment to match resonance frequencies, and thus there is no influence on relative quality of radiation characteristics. For easier comparison, the simulation is adjusted so that best radiation efficiency can always be acquired in the open state of the case.

FIGS. 31 to 33 respectively show impedance and return losses in the open state, the closed state, and the reverse state of the case in “Conventional Example 1”. A marker (triangle 1) is set to 1575.42 MHz used for the GPS. As described above, in the opened state of the case (FIG. 31), a return loss is equal to or less −10 dB, meaning good characteristics. However, in the closed state (FIG. 32), since the antenna comes into close proximity to the operation side case, impedance shifting occurs, deteriorating return losses. In the reverse state (FIG. 33), since the antenna and the operation side case are in closest proximity each other, return losses greatly deteriorate.

For “Conventional Example 2” that pertains to the antenna arrangement that is an improvement of “Conventional Example 1” in deterioration in the reverse state, FIGS. 34 to 36 respectively show simulation results. In the opened state of the case (FIG. 34), a return loss is equal to or less than −10 dB, meaning good characteristics. In “Conventional Example 2”, in the closed state and the reverse state, the antenna elements are set at positions where distances between the antenna elements and the operation side case are equal. Accordingly, return losses are almost equal between the closed state (FIG. 35) and the reverse state (FIG. 36). While a significant deterioration in the reverse state of “Conventional Example 1” is greatly rectified, in the closed state, because of the shorter distance between the antenna element and the operation side case, deterioration is greater than in “Conventional Example 1”.

FIGS. 37 to 39 respectively show the simulation results of the antenna according to the present invention. In the opened state of the case (FIG. 37), a return loss is equal to or less than −10 dB, meaning good characteristics. Returns losses are equal between the closed state (FIG. 38) and the reverse state (FIG. 39), and values better than those of “Conventional Example 1” and “Conventional Example 2” are acquired.

FIGS. 40 and 41 show the respective simulation results in terms of antenna radiation efficiency. FIG. 40 shows comparison between “Conventional Example 1” and “Conventional Example 2”. Referring to FIG. 40, while significant deterioration in the reverse state of “Conventional Example 1” is prevented in “Conventional Example 2”, in the closed state, the return loss deteriorates by about 3 dB in “Conventional Example 2” compared with “Conventional Example 1”.

FIG. 41 shows comparison of the antennas between present invention and “Conventional Example 1”, “Conventional Example 2”. In the antenna according to the present invention, in the closed state, radiation efficiency almost equal to that of “Conventional Example 1” is acquired. In the reverse state, radiation efficiency almost equal to that in the closed state of “Conventional Example 1” is acquired.

According to the present invention, even when the operation side case is filled with many metals such as batteries, substrates or reinforcing plates, satisfactory radiation characteristics can be acquired. Because the device of the present invention is different from a conventional mobile terminal, it is therefore unnecessary to prevent the antenna from the metals of the operation side case which faces the antenna located in the display side case when folded. As a result, reinforcing plates can be arranged up to the tip of the operation side case, and a mobile terminal stronger than conventionally can be realized.

The mobile terminal of the embodiment has been described by taking the example of a GPS antenna. However, corresponding frequencies can be easily changed by changing the element shapes or the position of the power supply unit. Thus, the mobile terminal of the embodiment can be used as an antenna of other frequency zones, such as Bluetooth (registered trademark) or a wireless LAN, and effects similar to those of the GPS can be expected.

For the manufacturing method of the antenna according to the present invention, gaps between the feeding points of the antenna elements and the power supply unit must be fixed, and high accuracy of 1 mm or less is required. Thus, the embodiment pertains to the example of the manufacturing method that integrally forms the metal conductors from resins. However, the antenna can be realized in the shape of, representatively, a chip antenna, where a metal film is deposited on a dielectric body. Further, the gaps between the antenna elements and the power supply unit can be substituted with chip components. In this case, the antenna can be manufactured as a substrate antenna.

As the shapes of the antenna elements, in addition to the flat-plate shape, a rod shape can be used. To capacitively couple the antenna element and the GND (ground) portion to operate the antenna as a GND in the folded state (closed state or reverse state) of the mobile terminal, a planar (including flat-plate shape) antenna element is desirably used so that a surface parallel to the GND surface (substrate surface) of the terminal can be enlarged to facilitate capacitive coupling.

The present invention is directed to the operation of the reverse F-type antenna. Generally, in view of the planar element configuration of the reverse F-type antenna, the planar antenna element is more desirable.

The embodiments of the present invention have been described. However, the present invention is not limited to the embodiments. Various changes understandable to those skilled in the art can be made to the configuration and the specifics of the present invention without departing from the scope of the invention.

This application claims priority from Japanese Patent Application No. 2010-256375 filed Nov. 17, 2010, which is hereby incorporated by reference herein in its entirety.

### REFERENCE NUMERALS

1, 2: Antenna element

1w, 2w: bent portion

3: Connecting member

4: Connection Member

5: Power supply member

6, 7: Gap

8: Operation side case

9: Display side case

10: Display unit

11: Hinge

12: Rotary unit

13: Antenna

1. An antenna comprising:
a pair of antenna elements arranged to be parallel to each other and to face each other;
a connecting member for connecting the pair of antenna elements at tips thereof to electrically short-circuit the same; and
power supply members capacitively coupled to feeding points of the pair of antenna elements to supply power.

2. The antenna according to claim 1, wherein there is a predetermined gap between the power supply member and the feeding point of each of the pair of antenna elements.

3. The antenna according to claim 1, wherein the pair of antenna elements includes flat-plate elements, and the flat-plate elements are arranged to be parallel to each other and to face each other.

4. A mobile terminal comprising:
the antenna according to claim 1.

5. The mobile terminal according to claim 4, wherein a display side case is foldable with respect to an operation side case and, at a tip of the display side case, antenna elements of the antenna are housed so that a longitudinal direction thereof can be orthogonal to a longitudinal direction of the display side case.

6. The mobile terminal according to claim 5, wherein when the display side case is folded in a state where a display unit is invisible to a user with respect to the operation side case, one of the pair of the antenna elements closer to the operation side case is set in a grounded state.

7. The mobile terminal according to claim 5, wherein when the display side case is folded in a state where a display unit is visible to a user with respect to the operation side case, one of the pair of the antenna elements closer to the operation side case is set in a grounded state.
